(19) United States
(12) Patent Application Publication
(10) Pub. No.: US 2006/0269898 A1
(43) Pub. Date: Nov. 30, 2006

(54) Inside Mouth Dental Light

(76) Inventor: Peter Lefferson, Saint Petersburg, FL (US)

Correspondence Address: PETER LEFFERSON, 6101 7 AVE. N., ST. PETERSBURG, FL, 33710-7015, US

(21) Appl. No.: 11/420,332

(22) Filed: May 25, 2006

Related U.S. Application Data
(60) Provisional application No. 60/595,035, filed on May 31, 2005.

(51) Int. Cl. A61C 1/00

(52) U.S. Cl. 433/29

(57) ABSTRACT

A dental light source brilliantly illuminates a dental patient's mouth by residing inside the mouth in place of or in addition to the conventional dental lamp. In the present art the conventional dental lamp is positioned in front of the patient's mouth and behind the dental practitioner's head. This dental lamp must be often adjusted by the dental practitioner in order to see particular parts of the patient's mouth. The dental practitioner's head and hands often block the light path. Earlier solutions to this problem have combined a light source and a dental mirror but these products were both very expensive and had cumbersome attached wires or fiber optic cables. These problems are cured by this new unique dental light source that may be temporarily clamped to a few teeth or be freely placed at any mouth location to brightly illuminate the rest of the mouth. This light source may use bright white light emitting diodes and be powered from enclosed battery cells or from an external battery pack that might reside in the patient's lap. This system can be immersed in a sanitizing solution and can easily be reused or be so inexpensive that it can be disposed of.

### BACKGROUND

The dental practitioner's most important tool is light to see the teeth he is working on. This light is most often provided by a large dental lamp that is suspended in front of the patient's mouth and at the same time, behind the dental practitioner. This common method of mouth illumination has several limitations. The dental practitioner must frequently adjust the lamp position in order to illuminate portions of the patient's mouth. The dental practitioner's head is often blocking the light because the lamp is behind the dental practitioner. Often the dental practitioner's hands and tools block the path of light. An alternative has been to put a light on the end of the dentist's drill handpiece to illuminate the operation field. However, this only works when the drill is in use and is not good for just an examination of the mouth and it only concentrates exactly where it is pointed. For exams the practitioner is subjected to only using a pen light or similar type device in addition to the overhead lamp.

This present invention solves both of these problems by placing the light source inside the patient's mouth. A light source composed of an array of light emitting diodes (LEDs) or some other light source secured inside the patients mouth provides abundant light where it is required. The dental practitioner can now move his head to better see his work and move his hands without blocking the light.

### SUMMARY

This invention gives the dental practitioner abundant light at the area of the mouth where he needs it. An array of low voltage cool operating LEDs is placed at a convenient location in the patient's mouth or on top of a few teeth on the side of the mouth opposite from where the dental practitioner is working. The array of LEDs may be secured on top of these teeth by a clamp or by some other means. Power for the array of LEDs is provided by an internal battery or by a small power pack that may rest in the patient's lap.

### DRAWINGS—FIGURES

FIG. 1 illustrates the invention mounted on top of a few teeth inside a mouth as it illuminates the teeth on the opposite side of the mouth.

FIG. 2 illustrates the invention as an unattached light source that can be placed at any location in the mouth where light is required.

FIG. 3 shows a dental light system with the light source wired to the power pack that provides current for the light source.

FIG. 4 is a perspective view of one embodiment of the invention with multiple light sources.

FIG. 5 is a perspective view of an embodiment of the invention with a single light source.

FIG. 6 shows a dental light system with an internal power supply and a switch to turn it on.

FIG. 7 shows a schematic of one of the many ways this dental light source can receive power from a wire connected power source.

FIG. 8 shows a schematic of one of many ways this dental light source can receive power from an internal power source.

### DRAWINGS—REFERENCE NUMBERS

10 open mouth
11. free light assembly
12 attached light assembly
14 light beams
15 wire
16 light source enclosure
17 single light source
18 LEDs Light Emitting Diodes
20 securing clamp
22 resistor
24 battery cells
26 switch
28 power pack
30 electrical schematic
32 battery compartment
34 push button switch

### DETAILED DESCRIPTION OF THE PREFERRED EMBODIMENT

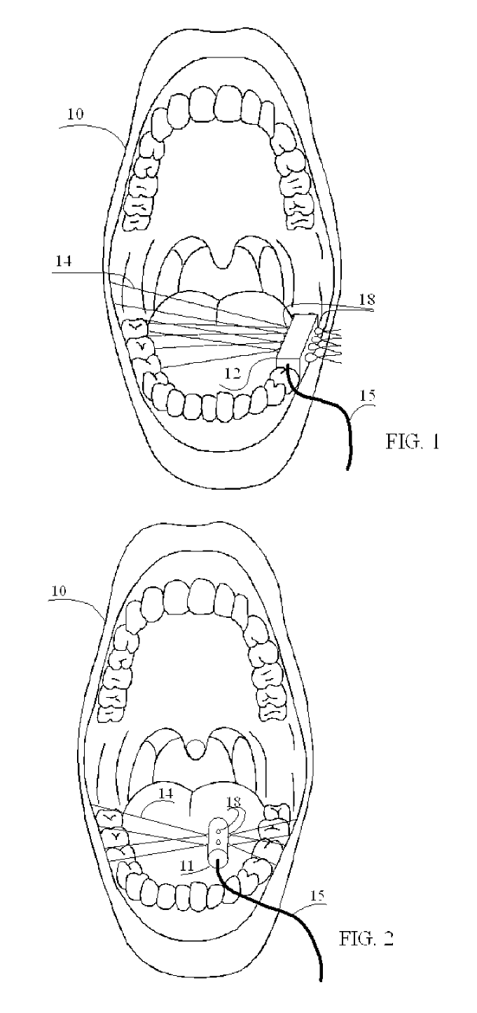

One embodiment of the Inside Mouth Dental Light is illustrated in FIG. 1 where an open patient's mouth 10 is seen to be illuminated by this unique invention. The complete attached light assembly 12 is secured to a few teeth on the right side of the mouth. Light beams 14 are illuminating both the left side of the mouth where the dental practitioner is working and the right cheek. When the dental practitioner is finished his work on the left side he will move the attached light source assembly 12 to the left side where the LEDs 18 will now illuminate the right side of the patient's mouth and the left cheek. In both locations of the attached light assembly 12 the thin wire 15 that supplies power to the light assembly is emerging from the end of the assembly that is facing the dental practitioner.

FIG. 2 shows another embodiment of the Inside Mouth Dental Light where the dental practitioner has more freedom to use the free light assembly 11 at any location with the mouth 10. The LEDs 18 are located at many and various places on the free light assembly and the beams of light 14 are able to illuminate hard to reach mouth 10 locations. The free light assembly 11 may contain only one light source as more advanced light sources become available that are appropriate for dental use.

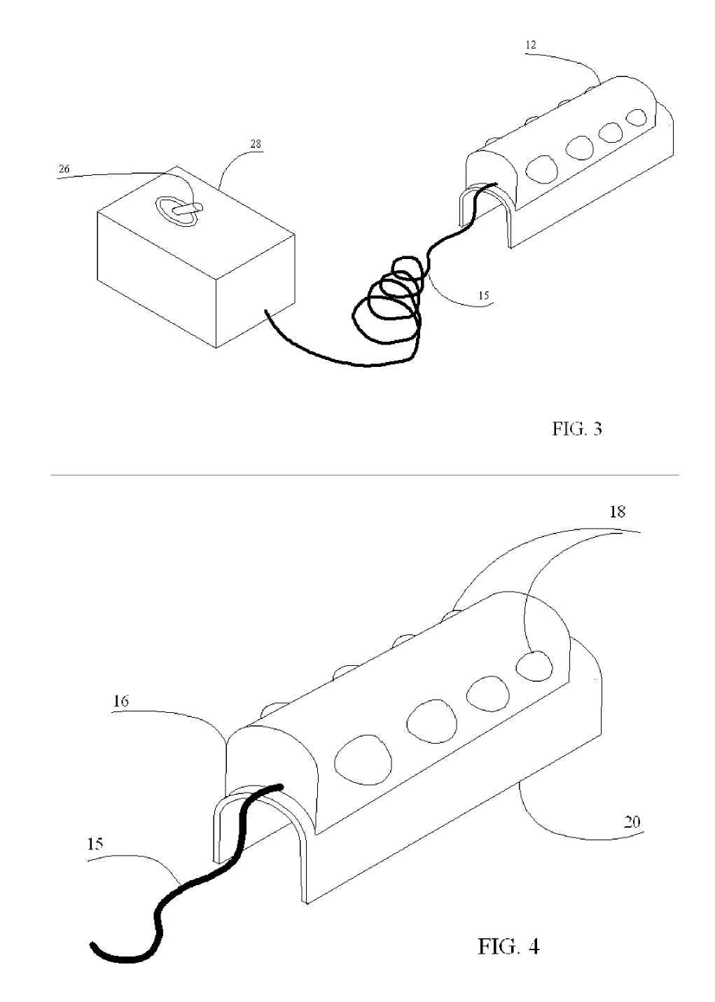

FIG. 3 shows one embodiment of the complete invention where light assembly 12 is attached to the power pack 28 by means of wire 15. Switch 26 provides a way for the user to turn on the light or to turn it off.

FIG. 4 illustrates a more detailed view of one embodiment of the Inside Mouth Dental Light. A light source enclosure 16 supports the array of LEDs 18. There are other types of light source than can be used here as well as the LED. The filament incandescent bulb is just one example. The LEDs 18 protrude from light source enclosure 16 and supply light in several directions so the dental practitioner can use the light array on either side of the patient's mouth. The light source enclosure 16 is secured to a few teeth or to a gum when there are no teeth by a securing clamp 20. A temporary type of glue or suction method might also be used to secure the light source enclosure.

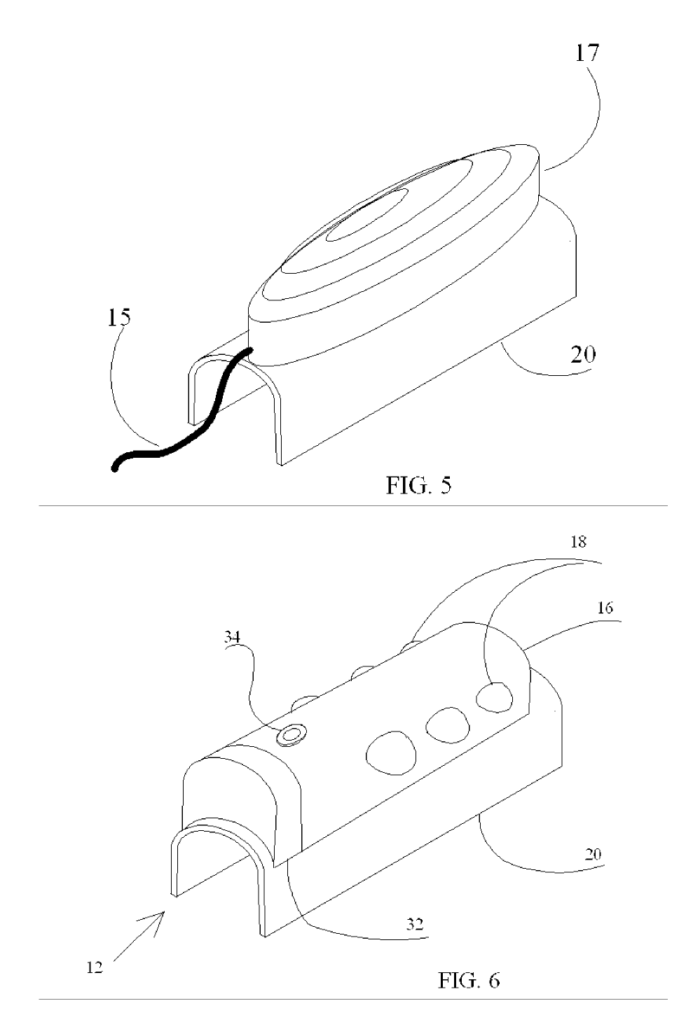

FIG. 5 shows the Inside Mouth Dental Light with a single light source 17

FIG. 6 shows one embodiment of the complete invention where the power source is inside the light assembly 12. The light source enclosure 16 supports the LEDs 18, a battery compartment 32, and a push button switch 34 that the dental practitioner would use to turn on and off the light source.

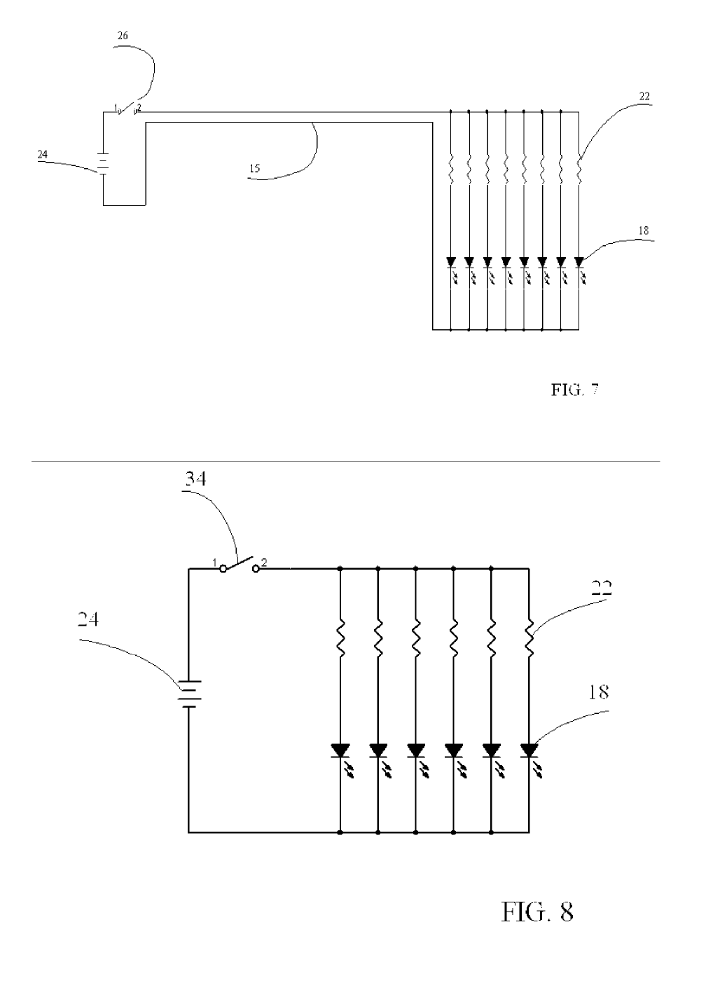

FIG. 7 provides an electrical schematic for only one of many ways that this Inside Mouth Dental Light can operate using an external power pack. In one embodiment the LEDs 18 along with their current controlling resistors 22 are secured inside the aforementioned light assembly 12. Each LED 18 in the array of LEDs is in series with a resistor 22 that controls the current to the individual LED 18. Battery cells 24 along with switch 26 located inside the power pack 28 provide electrical current through wire 15 for the LEDs 18.

FIG. 8 provides an electrical schematic for only one of many ways that this Inside Mouth Dental Light can operate using an internal power pack. In one embodiment the LEDs 18 along with their current controlling resistors 22, battery cells 24, and push button switch 34 are secured inside the aforementioned light source enclosure 16. Each LED 18 in the array of LEDs is in series with a resistor 22 that controls the current to the individual LED 18.

Although the description above contains many specificities, these should not be construed as limiting the scope of the invention but as merely providing illustrations of some of the presently preferred embodiments of this invention.

Operation

The dental practitioner may use the Inside Mouth Dental Light in place of the more conventional dental lamp or as a supplement to that lamp. As he prepares the patient's mouth for examination or dental work on the left side of the patient's mouth the dental practitioner will place the new light source assembly on the teeth in the patient's right side.

For the embodiment with an external power pack, he will place the power pack on the patient's lap or clip it to a convenient place on the patient's clothes. He will turn on the power pack switch and work on the left side of the patient's mouth. When he is completed with the left side he will reverse the process on the right side with great ease.

In another embodiment of The Inside Mouth Dental Light where there is no clamping device, this light source may be place at any location inside the patient's mouth.

What is claimed is:

1. A dental lighting system comprising:
a. a light source enclosure having a length to cover one or several teeth and a width that is sufficient to allow placement on top of the patient's teeth or gums,
b. light source,
c. a means to fasten said light source enclosure inside patient's mouth,
d. a means to provide power to said light source,
whereby said dental lighting system allows a dental practitioner to have abundant light inside the patient's mouth without hands blocking the light and without often adjusting the light source placement as with the conventional dental lamp that resides behind the dental practitioner's head or being confined to the use of a dental drill handpiece light or a pen light device.

2. A dental lighting system of claim 1 wherein said light source enclosure has a securing means that will allow said light source enclosure to be coupled to one or more teeth or gum whereby securing the lighting system while the dental practitioner works on other areas in the patient's mouth.

3. The securing means of claim 2 that is a metal clamp thereby securing the light source enclosure within the patient's mouth.

4. The securing means of claim 2 that is a clamp made out of a soft material that will protect the gums but have sufficient spring type retention thereby securing the light source enclosure within the patient's mouth.

5. The securing means of claim 2 that is an adhesive thereby securing the light source enclosure within the patient's mouth.

6. The securing means of claim 2 that employs a suction thereby securing the light source enclosure within the patient's mouth.

7. A dental lighting system of claim 1 wherein the source of power is from an external power pack that delivers electrical current to the dental lighting system through an attached wire.

8. A dental lighting system of claim 1 having a source of power that is contained within the light source enclosure.

9. A dental lighting system without a clamping means comprising:
a. a light source enclosure,
b. light source,
c. a means to provide power to said light source,
whereby said dental lighting system allows a dental practitioner to have abundant light inside the patient's mouth without hands blocking the light and without often adjusting the light source placement as with the conventional dental lamp that resides behind the dental practitioner's head.

10. A dental lighting system of claim 9 wherein the source of power is from an external power pack that delivers electrical current to the dental lighting system through an attached wire.

11. A dental light system of claim 9 wherein the source of power is contained within the light source enclosure.
